(19) United States
(12) Patent Application Publication
(10) Pub. No.: US 2016/0347924 A1
(43) Pub. Date: Dec. 1, 2016

(54) Open Cell Foam Composition, Hydrophobic Open Cell Foam and a Method for Preparing Them using the Same

(71) Applicant: DONGSUNG CHEMICAL CO., LTD., Busan (KR)

(72) Inventors: Byeong Hwan Min, Gyeongsangnam-do (KR); Pan Seok Seo, Busan (KR); Young Do Park, Busan (KR); Byung Youn Gwack, Gyeongsangnam-do (KR)

(21) Appl. No.: 15/117,678

(22) PCT Filed: Feb. 11, 2014
(86) PCT No.: PCT/KR2014/001126

§ 371 Date: Aug. 9, 2016

(51) Int. Cl. C08J 9/28; C08K 5/5415; C08K 3/36

(52) U.S. Cl. CPC C08J 9/28; C08K 3/36; C08K 5/5415; C08J 2205/05; C08J 2361/28

(57) ABSTRACT

The present invention relates to an open-cell foam composition, a hydrophobic open-cell foam prepared using the composition, and a method for preparing the hydrophobic open-cell foam. Specifically, the present invention provides an open-cell foam composition and a method for preparing a hydrophobic open-cell foam having hydrophobicity/oleophobicity and improved heat resistance as a result of partially or completely coating the surface of the inner framework structure of an open-cell foam, prepared using the composition, with silica gel, in which the method comprises continuously and efficiently preparing a melamine foam from a resin.

### TECHNICAL FIELD

The present invention relates to an open-cell foam composition, a hydrophobic open-cell foam prepared using the composition, and a method for preparing the hydrophobic open-cell foam, and more particularly, to an open-cell foam composition and a method in which a hydrophobic open-cell foam having hydrophobicity/oleophobicity and improved heat resistance as a result of partially or completely coating the surface of the inner framework structure of an open-cell foam, prepared using the open-cell foam composition, with silica gel, is prepared by a continuous process.

### BACKGROUND ART

Foams prepared from resin condensation products are organic foams having an open cell structure. These foams have both excellent thermal insulation properties and sound absorption properties, and thus are used in various applications, including thermal insulating materials, soundproofing materials, sound absorbing materials, interior material and the like, for the purposes of thermal insulation and sound absorption in various buildings and vehicles. In addition, these foams have fire safety and high resistance to heat, and thus the use of these foams in various applications has been developed.

As a prior art document related to these foams, U.S. Pat. No. 4,511,678 proposes a technology regarding a melamine formaldehyde condensate-based resilient foam which can be obtained from a melamine-formaldehyde condensation product. The melamine-formaldehyde foam has excellent flame retardant properties by virtue of its chemical composition, but has the property of being decomposed rapidly at a temperature of 350° C. or higher because the heat resistance of the melamine formaldehyde condensation product is low. Due to this property, the melamine-formaldehyde foam as described above does not sufficiently satisfy the heat resistance performance of foams required in the construction field. In addition, the resin foams problems in that they absorb steam, and water due to the hydrophobic property of the open cells and in that the physical properties and thermal. insulation properties thereof are reduced with the passage of time.

Furthermore, European Patent Publication No. 2007023160 (Korean Patent Application No. 2008-7006931) discloses a water-vapor repellent, open-pored foam, material and a method for producing the same, in which a melamine foam is coated with polyvinylidene halide and a fluorocarbon resin and/or a silicone resin to make the melamine foam hydrophobic. In addition, European Patent Publication No. 2007023118 (Korean Patent Application No. 2008-7004126) discloses an open-cell foam having fire-retardant and oleophobic/hydrophobic properties and a method for producing the same, in which a melamine foam is coated with a fire-retardant substance, a fluorocarbon resin and a silicone resin to improve the hydrophobic and fire-retardant properties of the foam.

Alkali silicate that is used as a flame-retardant material in the above-described patent documents has problems in that it can reduce hydrophobicity due to the property of the alkali metal that is easily soluble in water and in that it requires high-temperature drying conditions for complete drying. Accordingly, there is still need for the development of a melamine foam-related technology which can effectively reduce hydrophobicity, does not require high-temperature heating conditions, and can sufficiently improve heat resistance.

### DISCLOSURE

### Technical Problem

Therefore, it is an object of the present invention to provide an open-cell foam composition and to provide a method in which a hydrophobic open-cell foam having hydrophobicity/oleophobicity and improved heat resistance as a result of partially or completely coating the surface of the inner framework structure of an open-cell foam, prepared using the open-cell foam composition, with silica gel, is prepared by a continuous process.

### Technical Solution

In accordance with one aspect of the present invention, there is provided an open-cell foam composition comprising an amino resin foam composition and a silica sol solution, wherein the silica sol solution comprises 1 mole of alkylalkoxysilane, 10-20 moles of alcohol, 2-6 moles of water, and 0.001-0.005 moles of an acidic catalyst.

In accordance with another aspect of the present invention, there is provided a method for preparing hydrophobic open-cell foam using the above-described open-cell foam composition, the method comprising: a process of preparing the open-cell foam composition; a process of irradiation with high-frequency microwaves; and a step of pressing under vacuum.

In accordance with still another aspect of the present invention, there is provided a hydrophobic open-cell foam which is prepared by the above-described method and which is based on an amino resin and has a three-dimensional mesh structure containing pores with different shapes, wherein the pores are coated thinly with silica gel.

Hereinafter, the present invention will be described in detail.

The present invention provides an open-cell foam and is technically characterized in that a hydrophobic open-cell foam having hydrophobicity/oleophobicity and improved heat resistance as a result of partially or completely coating the surface of the inner framework structure of the open-cell foam is prepared by a continuous process.

Specifically, the open-cell foam composition according to the present invention comprises an amino resin foam composition and a silica sol solution, wherein the silica sol solution comprises 1 mole of alkylalkoxysilane, 10-20 moles of alcohol, 2-6 moles of water, and 0.001-0.005 moles of an acidic catalyst.

For example, the amino resin foam composition may be a dispersion obtained by dispersing 0.2-1 part by weight of a condensing agent, 3-15 parts by weight of an emulsifying agent, 5-20 parts by weight of a blowing agent and 2-10 parts by weight of a curing agent in a condensation product of an amino resin and an aldehyde compound, the dispersion having a pH of 6-10.

Herein, the condensation product of the amino resin and the aldehyde compound may be a reaction product obtained by reacting 30-50 parts by weight of the amino resin with 50-70 parts by weight of the aldehyde compound in the presence of a basic catalyst, and may have a solid content of 60-80 wt % and a viscosity of 500-10,000 cps.

The amino resin that is used in the present invention may be, for example, one or more selected from the group consisting of melamine, urea, urea derivatives, guanamine, benzoguanamine, urethane, carboxamide, dicyandiamine, sulfonamide, aliphatic amines, glycol, hydroquinone, resorcinol, aniline, xylenol, phenol, and derivatives thereof.

Furthermore, the aldehyde compound that is used in the present invention may be one or more selected from the group consisting of formaldehyde, paraformaldehyde, acetaldehyde, trimethylolacetaldehyde, benzaldehyde, glutaraldehyde, phthalaldehyde, and terephthalaldehyde.

In addition, the condensing agent may, for example, be one selected from the group consisting of sodium bisulfite, ammonium sulfate, and sodium, formate. is The condensing agent may be added during or after a condensation reaction in an amount of 0.2-2 parts by weight or 0.5-1 part by weight based on 100 parts by weight of the condensation product of the amino resin and the aldehyde product. When the condensing agent is added in an amount within the above range, there are advantages in that a foam is formed through a sufficient polycondensation reaction, and in that the mechanical strength and heat resistance of the foam can be prevented from being reduced due to a reduction in the cell density, and also in that the polycondensation reaction does not progress so that it is easily controlled.

As a blowing agent for expanding the condensation product of the amino resin and the aldehyde compound, a physical blowing agent or a chemical blowing agent may, for example, be used. Alternatively, the blowing agent that is used in the present invention may be may be one or more selected from among halogenated hydrocarbons such as trichloromonofluoromethane, trichloromonofluoroethane, dichloromonofluoroethane and the like, furan, pentane, heptane, cyclohexane, cyclopentane, and isopropyl ether. The blowing agent may be added in an amount of 5-20 parts by weight or 10-16 parts by weight based on 100 parts by weight of the condensation product of the amino resin and the aldehyde product. When the blowing agent is added in an amount within the above range, a foam will be easily produced using the condensation product, and the mechanical strength and heat resistance properties of the produced foam can be prevented from being reduced due to a reduction in the cell density of the foam.

The emulsifying agent serves to emulsify the blowing agent and stabilize the foam, and may, for example, be selected from among an anionic surfactant, a cationic surfactant, a nonionic surfactant, and mixtures thereof.

Herein, the anionic surfactant may be one or more selected from among, for example, alkyl phosphate, polyoxyethylene alkyl phosphate, alkyl sulfonate, polyoxyethylene alkyl aryl sulfite, polyoxyethylene alkyl sulfite, sodium dodecylbenzene sulfonate, and sodium dodecyl sulfonate.

The nonionic surfactant may be, for example, alkylphenol polyglycol ether, fatty acid polyglycol ether, an ethylene oxide propylene oxide block copolymer, amine oxide, or the like, and the cationic surfactant may be, for example, an alkylbenzyldimethylammonium salt, an alkylpyridinum salt, an alkyltriammonium salt, or the like.

The emulsifying agent may be added in an amount of 1-20 parts by weight or 3-15 parts by weight based on 100 parts by weight, of the condensation product of the amino resin and the aldehyde compound. When the emulsifying agent is added in an amount within the above range, the additives will be easily dispersed in the condensation product, and the rigidity and compressive strength of the formed foam will not be reduced.

The curing agent that is used in the present invention may be an inorganic acid or an organic acid. Specifically, the curing agent may be one or more sulfuric acid, phosphoric acid, hydrochloric acid, nitric acid, acetic acid, oxalic acid, formic acid, benzenesulfonic acid, toluenesulfonic acid, phenolsulfonic acid, aminosulfonic acid, and xylenesulfonic acid.

The curing agent is preferably added in an amount of 2-10 parts by weight or 4-7 parts by weight based on 100 parts by weight of the condensation product of the amino resin and the aldehyde compound. When the curing agent is added in an amount within the above range, the foam will be easily formed, and the reduction in physical properties (such as resilience) of the foam by an increase in the thickness of foam cells will not occur.

In addition, the alkylalkoxysilane may be, for example, one or more selected from the group consisting methyltrimethoxysilane, methyltriethoxysilane, ethyltrimethoxysilane, ethyltriethoxysilane, dimethyldimethoxysilane, and dimethyldiethoxysilane.

For reference, dimethyldimethoxysilane can reduce network structure-forming groups, compared to methyltrimethoxysilane, thereby increasing flexibility of silica gel and also increasing the hydrophobicity of the foam.

In one embodiment, a method for preparing a hydrophobic open-cell foam using the open-cell foam composition according to the present invention may comprise: a process of preparing the open-cell foam composition; a process of irradiation with high-frequency microwaves; and a process of pressing under a vacuum.

In another embodiment, the process of preparing the open-cell foam composition, the process of irradiation with high-frequency microwaves, and the process of pressing under a vacuum may be continuously performed.

In still another embodiment, the process of preparing the open-cell foam composition, the process of irradiation with high-frequency microwaves, and the process of pressing under a vacuum may be continuously performed and may comprise the steps of: irradiating the amino resin foam composition of the open-cell foam composition with high-frequency microwaves, thereby obtaining a foam having a three-dimensional mesh structure containing pores with different shapes; and impregnating the foam with the silica sol solution of the open-cell foam composition, pressing the impregnated foam under a vacuum, and additionally irradiating the pressed foam with high-frequency microwaves.

For reference, as used herein, the expression “foam having a three-dimensional mesh structure containing pores with different shapes”, unless otherwise specified, refers to a foam having a three-dimensional network structure containing pores which have different shapes due to the inner framework structure of the mesh structure and also have a size of, for example, 50-250 μm (see FIGS. 2a and 2b).

Herein, the foam may he prepared by allowing the amino resin foam composition to react at a temperature of 70 to 100° C. or 70 to 80° C. and a pressure of 100-500 KPa or 100-300 KPa for 1-3 hours or 2-3 hours, and then cooling the reaction product to room temperature. Within the range of the reaction conditions, over-expansion of the condensate can be prevented.

The polycondensation reaction may be carried out in a conventional manner. When the polycondensation reaction is carried out under the above-described reaction conditions, a resin condensation product can be obtained. Within the ranges of the reaction conditions, the reaction yield or the purity of the condensation product is not reduced.

The high-frequency microwave irradiation may be performed with an output 3-20 W at a frequency of 0.915-5.8 GHz or 0.95-3.0 GHz per g of a dispersion of the amino resin foam composition at a temperature of 180 to 210° C. The high-frequency microwave irradiation may be performed using a plurality of magnetrons, and it is preferred to ensure a uniform distribution to the highest possible extent during the irradiation.

Within the ranges of the frequency and output of the high-frequency microwave irradiation, the condensation product is suitably expanded, and over-expansion of the condensation product is not prevented so that the mechanical properties of the foam will not be reduced.

In addition, the method may further comprise a step of heat-treating the foam at a temperature of 150 to 250° C., for 30-60 minutes during the continuous process. Within the ranges of the reaction conditions, the remaining water, blowing agent and formaldehyde, etc., may be efficiently removed.

As described above, the silica sol solution can be formed by mixing 1 mole of alkylalkoxysilane, 10-20 moles or 13-18 moles of alcohol, 2-6 moles or 3-5 moles of water and 0.001-0.005 moles or 0.003-0.005 moles of an acidic catalyst, and allowing the mixture to react for 30-90 minutes or 30-60 minutes. At the above composition ratio, alcohol and water are added so that the alkylalkoxysilane can be suitably hydrolyzed, and the acidic catalyst such as hydrochloric acid is added in order to control the rates of the hydrolysis and condensation reactions.

For reference, the above-described reaction corresponds to a chemical modification process in which an oligomer-type sol is produced by the hydrolysis and condensation reactions of a metal alkoxide in a solution and then becomes a gel having a four dimensional network structure. Furthermore, when the liquid in the solution is evaporated, xerogel or aerogel is formed, and the pore size and structure of the formed gel can be determined by the pH used during the hydrolysis and condensation reactions. Specifically, a gel produced under a basic condition has a large pore size and a small surface area, and the pores of xerogel may be dependent on the conditions of aging before removal of the solvent, pH, the pH of water during a washing process, etc. This is because, in the presence of a basic catalyst, the condensation reaction rate is higher than the hydrolysis reaction rate so that colloidal particles with a compact structure will be obtained, and in the presence of an acidic catalyst, the hydrolysis reaction rate is higher than the condensation reaction rate so that a product with a linear structure will be obtained.

In addition, the product can also vary depending on the amount of water added. For example, if the molar ratio of water/silane is 4 or less, a condensation reaction will occur before complete hydrolysis of the silane, and thus a linear siloxane polymer will be likely to be produced, whereas if the amount of water is relatively large, the silane will be easily hydrolyzed and will grow three-dimensionally, and thus spherical silica particles will be easily produced.

After the foam is immersed in the silica sol solution, the silica sol solution may be dispersed by stirring or ultrasonic irradiation for uniform dispersion.

Thereafter, the foam impregnated with the silica sol solution may be pressed in a vacuum by use of a vacuum press or the like, thereby removing 90% or more of the silica sol solution. As described in Examples below, removal of the silica sol solution by use of the vacuum press shows efficiency higher than when the silica sol solution is removed using a general press.

After the vacuum press process, the remaining silica sol solution is converted to silica gel by additional irradiation with high-frequency microwaves while the remaining solvent, is completely removed. Specifically, the pores are coated thinly with the xerogel or aerogel converted from the silica sol solution (see FIG. 2a).

For reference, the process of drying with additional irradiation with high-frequency microwaves has an advantage over a process of drying with heat in that heat is easily transferred into the foam to efficiently remove the remaining solvent, and thus the process time can be greatly reduced.

The hydrophobic open-cell foam according to the present invention can be prepared by the above-described method. Specifically, the open-cell foam is based on an amino resin and has a three-dimensional mesh structure containing pores with different shapes, wherein the pores are coated thinly with silica gel.

For example, as described in Examples below, the hydrophobic open-cell foam may comprise silica gel in an amount equivalent to 1.1-10 times or 1.3-5 times the weight of an initial foam containing no silica gel.

In addition, the hydrophobic open-cell foam according to the present invention shows not only hydrophobicity and also improved heat resistance (see FIG. 1).

Furthermore, the hydrophobic open-cell foam has a bulk density of 3-100 kg/m³ or 10-100 kg/m³, and may be used as a sound-absorbing insulation material or a flame-retardant insulation material. For example, it may be used as a sound-absorbing and thermal insulation material in transport equipment, such as a vehicle engine cover, a railway vehicle sound-absorbing material or an aircraft cushion material, a sound-absorbing and thermal insulation material in buildings, or a flame-retardant and sound-absorbing material in the electrical/electronic field, such as an electronic product cover.

### Advantageous Effects

According to the present invention, there is provided an open-cell foam composition which can provide an open-cell foam having hydrophobicity/oleophobicity and improved heat resistance as a result of partially or completely coating the surface of the inner framework structure of the open-cell foam with silica gel, a hydrophobic open-cell foam prepared using the composition, and a method for preparing the hydrophobic open-cell foam, which comprises continuously and efficiently preparing a melamine foam from a resin.

### DESCRIPTION OF DRAWINGS

FIG. 1 is a graph comparing the heat resistance of Example 1 of the present invention with that of Comparative Example 1.

FIG. 2 shows 500× electron microscope photographs of foam of Example 1 of the present invention and a foam of Comparative Example 1. FIG. 2a: Example 1; and FIG. 2b: Comparative Example 1.

### MODE FOR INVENTION

Hereinafter, the present invention will be described in detail with reference to examples. It is to be understood, however, that these examples are for illustrative purposes and are not intended to limit the scope of the present invention.

### EXAMPLE 1

Step 1: Preparation of Foam from Open-Cell Foam Composition

40 parts by weight of melamine and 60 parts by weight of formaldehyde were stirred in the presence of a sodium hydroxide catalyst at 70° C. and 100 KPa for 3 hours, thereby synthesizing a condensation product. Next, the condensation product was cooled for one day. The resulting condensation product had a solid content of 63 wt %, a viscosity of 1,000 cPs and a pH of 8.9.

To the condensation product, 1 part by weight of sodium formate and 3 parts by weight of sodium dodecylbenzene sulfonate were added, and the mixture was dispersed. Next, 15 parts by weight of isohexane and 5 parts by weight of formic acid were added to the dispersion, followed by stirring at 23° C. for 2 minutes.

The stirred dispersion was irradiated with microwaves with a frequency of 2.45 GHz in a microwave generator (model MM-344L, LG Electronics Inc.) with an output of 20 W per g of the sample at 200° C., thereby preparing a foam.

Step 2: Preparation of Silica Sol Solution

1 mole of trimethoxysilane was added to a mixture of 4 moles of distilled water and 15 moles of methanol and stirred at 25° C. for 10 minutes, and then 0.005 moles of hydrochloric acid was added thereto, followed by stirring for 10 minutes. Next, the stirred solution was subjected to a hydrolysis reaction 60 minutes, thereby preparing a silica sol solution.

Step 3: Impregnation Process

The foam (size: 100 mm×100 mm×100 mm) prepared in step 1 was immersed in an impregnation bath containing the silica sol solution of step 2, and was impregnated with the silica sol solution while the silica sol solution was stirred and circulated.

Step 4: Primary Removal of Silica Sol Solution

The impregnated foam was taken out and was 90% pressed (from a 100 mm thickness to a 10 mm thickness) using a vacuum press at a vacuum pressure of −760 mmHg for 2 minutes, thereby removing the silica sol solution. The weight of the foam from which the silica sol solution was primarily removed was two times greater than the initial weight.

Step 5: Removal of Remaining Silica Sol Solution and Gelling/Coating

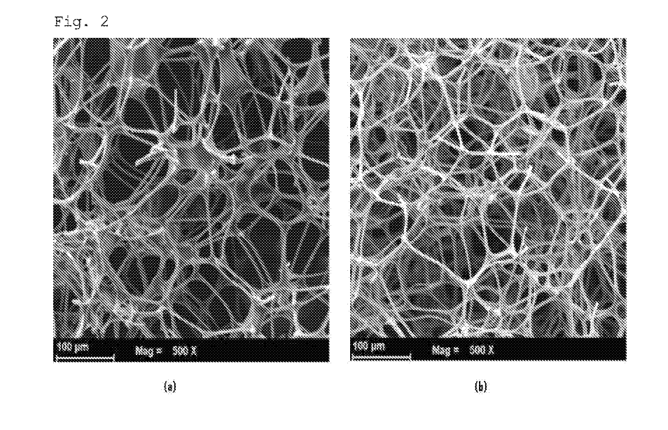

Using the microwave generator used in step 1, the solvent in the remaining silica sol was removed under the same conditions as used in step 1. During this process, the silica sol was converted to silica gel (xerogel type) while a thin coating layer was formed on the surface of the inner framework structure of the melamine foam (the surface means the surface of pores having different shapes and a pore size of 50-250 μm) (see FIG. 2a).

### EXAMPLE 2

Steps 1 to 5 of the same process as described in Example 1 were repeated, except that 20 parts by weight of melamine, 20 parts by weight of urea and 60 parts by weight of acetaldehyde were used instead of 40 parts by weight of melamine and 60 parts by weight of formaldehyde in step 1 (preparation of foam from open-cell foam composition) of Example 1) and that the produced condensation product had a solid content of 63 wt %, a viscosity of 700 cPs and a pH of 8.75, thereby forming a thin coating layer on the surface of the inner framework (different pores) of the melamine foam.

### COMPARATIVE EXAMPLE 1

Step 1 (preparation of foam, from open-cell foam composition) in Example 1 was performed, and then steps 2 to 5 were not repeated. The produced condensation product had a solid content of 63 wt %, a viscosity of 1,000 cPs and a pH of 89.

### COMPARATIVE EXAMPLE 2

The same process as described in Example 1 was repeated, except that the thickness of the foam was 90% pressed using a general press instead of the vacuum press in step 4 (primary removal of silica sol solution) of Example 1 (see FIG. 2b).

Measurement of Physical Properties

The physical properties (bulk density, water absorption rate, heat resistance and the amount of the remaining silica sol) of the foam prepared in each of Examples 1 and 2 and Comparative Examples 1 and 2 were measured in the following manner.

Bulk density: the density of the foam was measured in accordance with KS M ISO 845.

Absorption rate: measured in accordance with KS L 9016 after immersion in water at 23° C. for 2 hours.

Heat resistance (thermal decomposition temperature; TGA Data): the thermal decomposition temperature of the foam was measured by performing thermogravimetric analysis (TGA) in accordance with KS M ISO 11358 at a heating rate of 10° C./min. In addition, the remaining weight at 750° C. was determined by the TGA measurement data, and the remaining weight value according to a temperature rise was expressed as percentages (%) relative to the initial weight taken as 100%.

Amount of the remaining silica sol: measured by subtracting the weight of the initial foam from the weight of the foam remaining after the silica sol was primarily removed through the press process after impregnation of the foam with the silica sol solution.

The results of measurement of the water absorption rates of the foams prepared in Examples 1 and 2 and Comparative Examples 1 and 2 are summarized in Table 1 below.

TABLE 1

| | | | Comparative | |
|---|---|---|---|---|
| | Example | | Example | |
| | 1 | 2 | 1 | 2 |
| Density (kg/m³) of coated | 18 | 16.5 | 9.5 | 36.8 |
| foam | | | | |
| Weight (g) of coated foam | 18.0 | 16.5 | 9.5 | 36.8 |
| Weight (g) of foam after 2 hrs | 66.0 | 68.3 | 1072.8 | 83.2 |
| of immersion in water | | | | |
| Water absorption rate (%) | 4.8 | 5.2 | 106.6 | 4.7 |

As can be seen in Table 1 above, each of the foams of

Examples 1 and 2 and Comparative Example 2 showed an increase in the bulk density due to the silica gel. coating, compared to that of Comparative Example 1, and showed a water absorption rate of only 4.7-5.2% when immersed in water at 23° C. for 2 hours. However, the silica gel-untreated foam of Comparative Example 1 showed a water absorption rate of 106.6%.

Namely, the foams of Examples 1 and 2 and Comparative Example 2 showed very low water absorption rates compared to that of Comparative Example 1, indicating that these foams were hydrophobically coated.

Meanwhile, in the case of Comparative Example 2, the amount of the remaining silica sol was large, and thus a large amount of drying time was required. Furthermore, the bulk density of the foam of Comparative Example 2 also greatly increased, indicating that it was coated with an increased amount of the silica gel. Nevertheless, the foam of Comparative Example 2 showed no great difference in water absorption rate from the foams of Examples 1 and 2, suggesting that the hydrophobic property of the foam of Comparative Example 2 was not improved.

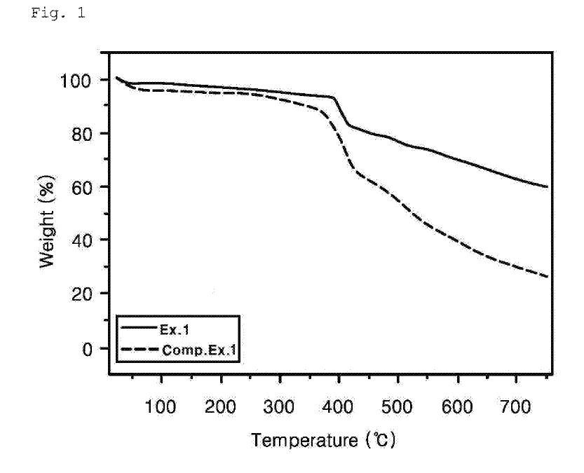

In addition, the heat resistances of the foams of Examples 1 and 2 and Comparative Examples 1 and 2 are shown in Table 2 below and FIG. 1.

TABLE 2

| | |
|---|---|
| | Comparative |
| Example | Example |

| | 1 | 2 | 1 | 2 |
|---|---|---|---|---|
| Thermal decomposition | 389 | 386 | 375 | 392 |
| temperature (° C.) | | | | |
| Remaining weight (%) at | 60.0 | 60.2 | 26.5 | 68.9 |
| 750° C. | | | | |

As can be seen in Table 2 above, the thermal decomposition temperatures of the foams of Examples 1 and 2 and Comparative Example 2 were about 15° C. higher than that of Comparative Example 1. As shown in FIG. 1, the foams of Examples 1 and 2 and Comparative Example 2 showed a slow decrease in the weight according to a rise in temperature. Particularly, the remaining weights of the test samples at 750° C. were 60% in Example 1 and 60.2% in Example 2, but 26.5% in Comparative Example 1, which was significantly low.

Furthermore, the remaining amounts of the silica sol in the foams of Examples 1 and 2 and Comparative Example 1 after the press process are summarized in Table 3 below.

TABLE 3

| | | | Comparative | |
|---|---|---|---|---|
| | Example | | Example | |
| | 1 | 2 | 1 | 2 |
| Weight (g) of initial foam | 9.5 | 9.5 | 9.5 | 9.5 |
| Weight (g) of foam after | 79.1 | 79.3 | — | 183.9 |
| pressing | | | | |
| Remaining amount (g) of silica | 69.6 | 69.8 | — | 174.4 |
| sol | | | | |

As can be seen in Table 3 above, in the case of Examples 1 and 2 performed using the vacuum press, 69.6-69.8 g of the silica sol remained in the foam, and in the case of Comparative Example 2 performed using the general press, 174.4 g of the silica sol remained in the foam. This suggests that the vacuum press is more suitable for removing the silica sol, compared to the general press.

FIGS. 2a and 2b shows 500× electron microscope photographs of the foams of Example 1 and Comparative Example 1, respectively. In FIG. 2b, it can be seen that the foam was not coated with the silica gel, and in FIG. 2a, it can be clearly seen that the surface of the inner framework structure of the foam as shown in FIG. 2b was coated with the silica gel.

1. An open-cell foam composition comprising:
an amino resin foam composition; and
a silica sol solution, wherein the silica sol solution comprises 1 mole of alkylalkoxysilane, 10-20 moles of alcohol, 2-6 moles of water, and 0.001-0.005 moles of an acidic catalyst.

2. The open-cell foam composition of claim 1, wherein the amino resin foam composition is a dispersion obtained by dispersing 0.2-2 parts by weight of a condensing agent, 1-20 parts by weight of an emulsifying agent, 5-20 parts by weight of a blowing agent and 2-10 parts by weight of a curing agent in a condensation product of an amino resin and an aldehyde compound, the dispersion having a pH of 6-10.

3. The open-cell foam composition of claim 2, wherein the condensation product of the amino resin and the aldehyde compound is a reaction product obtained by reacting 30-50 parts by weight of the amino resin with 50-70 parts by weight of the aldehyde compound in the presence of a basic catalyst, and has a solid content of 60-80 wt % and a viscosity of 500-10,000 cps.

4. The open-cell foam composition of claim 2, wherein the amino resin is one or more selected from the group consisting of melamine, urea, urea derivatives, guanamine, benzoguanamine, urethane, carboxamide, dicyandiamine, sulfonamide, aliphatic amines, glycol, hydroquinone, resorcinol, aniline, xylenol, phenol, and derivatives thereof.

5. The open-cell foam composition of claim 2, wherein the aldehyde compound is one or more selected from the group consisting of formaldehyde, paraformaldehyde, acetaldehyde, trimethylolacetaldehyde, benzaldehyde, glutaraldehyde, phthalaldehyde, and terephthalaldehyde.

6. The open-cell foam composition of claim 1, wherein the alkylalkoxysilane is one or more selected from the group consisting of methyltrimethoxysilane, methyltriethoxysilane, ethyltrimethoxysilane, ethyltriethoxysilane, dimethyldimethoxysilane, and dimethyldiethoxysilane.

7. A method for preparing a hydrophobic open-cell foam comprising:
preparing an open-cell foam composition comprising;
an amino resin foam composition; and
a silica sol solution, wherein the silica sol solution comprises 1 mole of alkylalkoxysilane, 10-20 moles of alcohol, 2-6 moles of water, and 0.001-0.005 moles of an acidic catalyst;
irradiating the open cell foam composition with high-frequency microwaves; and
pressing the open cell foam composition under a vacuum.

8. The method of claim 7, wherein the process of preparing the open-cell foam composition, the process of irradiating the open cell foam composition with high-frequency microwaves, and the process of pressing the open cell foam composition under a vacuum are continuously performed.

9. The method of claim 7, wherein the process of preparing the open-cell foam composition, the process of irradiating the open cell foam composition with high-frequency microwaves, and the process of pressing the open cell foam composition under a vacuum are continuously performed and further comprise the steps of:
irradiating the amino resin foam composition of the open-cell foam composition with high-frequency microwaves, thereby obtaining a foam having a three-dimensional mesh structure containing pores with different shapes; and
impregnating the foam with the silica sol solution of the open-cell foam composition, pressing the impregnated foam under a vacuum, and additionally irradiating the pressed foam with high-frequency microwaves.

10. The method of claim 9, wherein the open cell foam composition is obtained by allowing the amino resin foam composition to react at a temperature of 70 to 100° C. and a pressure of 100-500 KPa for 1-3 hours or 2-3 hours, followed by cooling to room temperature.

11. The method of claim 9, wherein the process of irradiating the open cell foam composition with the high-frequency microwaves is performed with an output of 3-20 W at a frequency of 0.915-5.8 GHz per g of a dispersion of the amino resin foam composition at a temperature of 180 to 210° C.

12. The method of claim 9, wherein the open cell foam composition is impregnating with the silica sol solution by immersing the open cell foam composition in the silica sol solution, and after the open cell foam solution is immersed in the silica sol solution, the silica sol solution is dispersed by stirring or ultrasonic irradiation.

13. The method of claim 9, wherein the pores of the open cell foam composition are coated thinly with a xerogel or aerogel converted from the silica sol solution by the additional irradiation with the high-frequency microwaves.

14. A hydrophobic open-cell foam which is prepared by the method of claim 7 and which hydrophobic open-cell foam comprises an amino resin and has a three-dimensional mesh structure containing pores with different shapes, wherein the pores are coated thinly with silica gel.

15. The hydrophobic open-cell foam of claim 14, wherein the hydrophobic open-cell foam contains silica gel in an amount equivalent to 1.1-10 times the weight of an initial foam containing no silica gel.

16. The hydrophobic open-cell foam of claim 14, wherein the hydrophobic open-cell foam has a bulk density of 3-100 kg/m³ and is used as a sound-absorbing thermal insulation material or a flame-retardant sound-absorbing material.
